(19) United States
(12) Patent Application Publication
(10) Pub. No.: US 2014/0172649 A1
(43) Pub. Date: Jun. 19, 2014

(54) Stock Aware Shelves

(71) Applicant: WAL-MART STORES, INC., Bentonville, AR (US)

(72) Inventors: Richard Neil Cancro, Portland, OR (US); Joel Bennett Acker, JR., Brush Prairie, WA (US); Douglas James Pedley, Portland, OR (US)

(73) Assignee: Wal-Mart Stores, Inc., Bentonville, AR (US)

(21) Appl. No.: 13/715,287

(22) Filed: Dec. 14, 2012

(51) Int. Cl. G06Q 10/08

(52) U.S. Cl. CPC G06Q 10/087
USPC 705/28

(57) ABSTRACT

A method for sending a request from a display apparatus server to a computing device corresponding to a retailer includes detecting a quantity of a selected item currently stocked at a display apparatus furnished within a facility of the retailer, the selected item indicating a product being offered for sale by the retailer. When the detected quantity of the selected item is less than a threshold, a request notification is generated to replenish the display apparatus with the selected item. The request notification is transmitted to the computing device corresponding to the retailer.

### BACKGROUND INFORMATION

1. Field of the Disclosure

The present invention relates generally to systems and methods for monitoring items stocked on a display apparatus within a facility. In particular, examples of the present invention are related to techniques for requesting a selected item currently stocked at a display apparatus to be replenished when a quantity of the selected item is less than a threshold and detecting a presence of one or more misplaced items currently stocked at the display apparatus.

2. Background

Shelves and garment racks are furnished within shopping facilities to display and present items offered for sale within the shopping facility. The retailer prefers and designates selected items for presentation on each shelf and/or garment rack to organize the items and make it easy for a customer to locate items that the customer desires. Customers are free to place an item obtained from the shelf or garment rack into a shopping cart for purchase at a check-out when the customer is finished shopping.

One drawback of physically allowing customers to retrieve the items from shelves and/or garment racks, is that the retailer is unable to determine the quantity of the item currently stocked and further has no way of determining if the item is no longer stocked unless a facility attendant personally views the shelf or garment rack. Having facility attendants constantly monitoring shelves and/or garment racks within the facility can be burdensome and can retract from the facility attendants' duty of attending to customers.

Another drawback, is that after the customer retrieves the item from the shelf and/or garment rack, the customer may later conclude that he or she no longer desires to purchase the item and simply places the item on another shelf and/or garment rack that does not prefer to stock the item. Accordingly, misplaced items can become lost within the facility until it is noticed that an alien item that has been misplaced is stocked on the wrong shelf or garment rack.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 schematically illustrates a display apparatus server in communication with a display apparatus and a retailer computing device, in accordance with an exemplary embodiment of the present disclosure;

FIGS. 2A-2B schematically illustrate the display apparatus including a display monitor of FIG. 1 corresponding to a shelf apparatus (FIG. 2A) and corresponding to a garment rack apparatus (FIG. 2B), in accordance with an exemplary embodiment of the present disclosure;

FIGS. 3A-3D schematically illustrate non-limiting examples of generated notifications displayed on a graphical user interface of the retailer computing device of FIG. 1, in accordance with an exemplary embodiment of the present disclosure;

FIGS. 4A-4B schematically illustrate non-limiting examples of information displayed on the display monitor of FIGS. 2A-2B, in accordance with an exemplary embodiment of the present disclosure;

FIG. 5 is a block diagram illustrating components of the display apparatus of FIG. 1, in accordance with an exemplary embodiment of the present disclosure;

FIG. 6 is a block diagram illustrating components of the display apparatus server of FIG. 1, in accordance with an exemplary embodiment of the present disclosure;

FIG. 7 is a block diagram illustrating components of the computing device of FIG. 1, in accordance with the present disclosure, in accordance with the present disclosure;

FIG. 8 is a flowchart illustrating an example method for generating a request notification to replenish a display apparatus with a selected item, in accordance with an exemplary embodiment of the present disclosure; and

FIG. 9 is a flowchart illustrating an example method for detecting a presence of one or more misplaced items currently stocked at a display apparatus, in accordance with an exemplary embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. Techniques for generating a notification based on user information when a presence of the mobile computing device is detected in a facility are described herein. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

It may be desirable to detect a quantity of a selected item currently stocked at a display apparatus furnished within a facility of a retailer and notify a facility attendant to replenish the display apparatus when the quantity of the selected item is running low or sold out. The display apparatus can be equipped with an integrated scale to weigh the currently stocked items and/or the display apparatus can be equipped with a radio frequency identification (RFID) reader device to read RFID labels respective to currently stocked items. Notifying facility attendants to replenish a display apparatus with a selected item, e.g., when it has been detected that the currently stocked selected item is running low or sold out, are described herein. The display apparatus can include a shelf apparatus and a garment rack apparatus. The display apparatus can be equipped with a display monitor to display at least one of a description of the selected item, customer reviews of the selected item and current promotions being offered by the retailer related to the selected item that is currently stocked at the display apparatus. As used herein, the term “facility” can refer to shopping venues, complexes and department stores, wherein a “facility attendant” can refer to one or more individuals, managers, stock persons, inventory personal, cashiers, or greeters employed by the retailer at a specific facility and on duty. The term “item” can refer to any type of indicator of a product sold by a retailer, wherein the term “product” can refer to groceries, foods, office supplies, clothing wares, or any other fungible goods sold by the retailer. Furthermore, the term “promotion” can refer to sales, coupons, and events offered by the retailer.

Additionally, providing an ability to detect a presence of one or more misplaced items currently stocked at the display apparatus may also be desirable to quickly and efficiently locate items stocked at locations they should not be. A display apparatus identifier corresponding to the display apparatus can be used to retrieve display apparatus preferences that indicate the selected item explicitly preferred by the retailer for being stocked at the display apparatus and location specific information indicating a specific section of the facility at which the display apparatus is located. Accordingly, item identifiers provided by RFID labels on respective items currently stocked at a display apparatus can be used to determine whether or not each item identifier corresponds to the selected item, whereafter item identifiers not corresponding to the selected item are detected as misplaced items.

Facilities are equipped with computing devices to obtain and view information. For example, a computing device stationed in the grocery department of the facility may receive a request notification to stock the produce shelf with more lettuce when a detected quantity of the lettuce is less than a threshold. Additionally, a mobile computing device corresponding to a facility attendant can be utilized to locate a desired item, whereafter the mobile computing device can receive a misplaced item notification that notifies the facility attendant that the desired item is a misplaced item. Such misplaced item notifications can be viewed on the mobile computing device and further provide a specific section of the facility at which the display apparatus currently stocking the misplaced item is located. As used herein, the term “computing device” can refer to mobile computing devices, such as mobile telephones, laptop computers, and tablet computers, or stationary computing devices.

In accordance with various embodiments of the present disclosure, techniques are described for transmitting a request notification to a computing device corresponding to the retailer when a detected quantity of a selected item currently stocked at a display apparatus is less than a threshold. Detecting the quantity of the selected item currently stocked at the display apparatus can include equipping the display apparatus with an integrated scale to weigh the items currently stocked, and estimating the quantity of the selected item based on a known weight of the selected item and total weight of the items currently stocked using the integrated scale. Additionally, or alternatively, each selected item currently stocked at the display apparatus can include a respective RFID label that broadcasts an item identifier corresponding to the selected item. Using the item identifier, the quantity of the selected item can be determined based on the quantity of item identifiers corresponding to the selected item. Transmitting the request notification to the computing device can include transmitting a restocking request notification to a mobile computing device of a facility attendant responsible for stocking shelves in a given department of the facility, the restocking request notification being indicative of a required quantity of the selected item needed to fulfill the desired quantity of the selected item stocked at the display apparatus. Additionally, the restocking request notification can provide a specific section of the facility at which the display apparatus that needs to be replenished is located. For example, a department, aisle and shelf number may be provided.

Furthermore, techniques are described for detecting a presence of one or more misplaced items currently stocked at a display apparatus. Based on a display apparatus identifier broadcasted from the display apparatus, display apparatus preferences being indicative of a selected explicitly preferred by the retailer for being stocked at the display apparatus and location specific information indicating a specific section of the facility at which the display apparatus is located can be retrieved. Using one or more item identifiers broadcasted from RFID labels respective to items currently stocked at the display apparatus, item identifiers (i.e., misplaced item identifiers) that do not correspond to the selected item can be used to detect the presence of the one or more misplaced items currently stocked at the display apparatus. In one embodiment, an alert notification can be transmitted to a computing device corresponding to the facility, the alert notification indicating the detected presence one or more misplaced items currently stocked at the display apparatus. Additionally, or alternatively, the misplaced item identifiers corresponding to the misplaced items can be stored in a misplaced item database, the misplaced item database storing misplaced item identifiers corresponding to misplaced items currently stocked at a plurality of display apparatuses. Further, each misplaced item identifier can be associated with and provide the location specific information for the display apparatus at which each misplaced item is currently stocked. In another embodiment, a facility attendant may broadcast a search request from a computing device to determine the availability of a desired item within the facility. A misplaced item identifier equivalent to the search request may be retrieved from the misplaced item database. For instance, the search request may include a key word, phrase, or serial number corresponding to the desired item. Accordingly, a misplaced item notification based on the retrieved misplaced item identifier may be transmitted to the computing device corresponding to the facility attendant. The retrieved misplaced item notification can include the associated location specific information of the display apparatus, wherein the misplaced item notification transmitted to the computing may include the specific section of the facility at which the display apparatus currently stocking the misplaced item that includes the desired item is located. For instance, the location specific information can include a map to lead the facility attendant to the desired item that has been misplaced. In another instance, the location specific information can simply provide a department and aisle number at which the desired item has been misplaced. Contrarily, an unavailable item notification can be transmitted to the computing device if none of the misplaced item identifiers stored in the misplaced item database are equivalent to the search request.

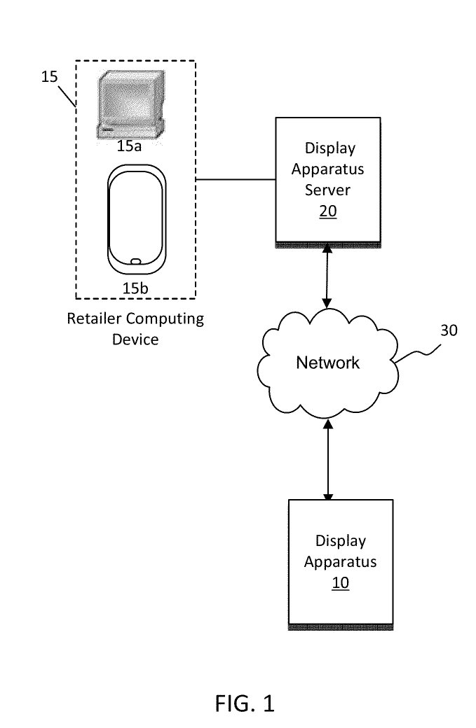

FIG. 1 illustrates a display apparatus server 20 in communication with a display apparatus 10 and a retailer computing device 15. The retailer computing device can include a stationary computing device 15a corresponding to a specific section of the facility, e.g., a sporting good department service desk, or a mobile computing device 15b corresponding to a facility attendant. While one display apparatus server 20 is illustrated, the term “display apparatus server” refers to one or more servers that operate in an individual or distributed manner. For instance, each display apparatus may include a respective “display apparatus server” or one “display apparatus server” may operate a plurality of display apparatuses. While one retailer computing device 15 is illustrated, the term “retailer computing device” refers to one or more computing devices that operate to transmit one or more inputs to the display apparatus server 20 for requesting the availability of a requested item. Similarly, the display apparatus server 20 can operate to transmit one or notifications to one or more retailer computing devices, the notifications including a retrieved misplaced item identifier corresponding to a misplaced item stored in a misplaced item database. The notifications can be generated using a processing device of the display apparatus server 20. Additionally, the display apparatus server 20 can operate to transmit one or more notifications to one or more retailer computing devices indicating a selected item needs to be replenished at the display apparatus device 10. Further, as used herein, the term “network” can refer to any communication network including, but not limited to, a wireless network, a cellular network, an intranet, the Internet, or combinations thereof.

While one display apparatus 10 is illustrated, the term “display apparatus” may include one or more display apparatuses furnished within the facility. In the illustrated example, the display apparatus server 20 may receive a display apparatus identifier broadcasted from the display apparatus 10 via the network 30. Display apparatus information may then be retrieved from a display apparatus database using the display apparatus identifier. Embodiments include the display apparatus information including display apparatus preferences provided by the retailer and stored in the display apparatus database. For instance, a facility manager may provide the display apparatus preferences using the retailer computing device 15, wherein the display apparatus preferences may be indicative of a selected item explicitly preferred by the retailer for being stocked at the display apparatus 10, a desired quantity of the selected item stocked at the display apparatus and a weight of the selected item stocked at the display apparatus 10. Additionally, the display apparatus server 20 may receive an item identifier broadcasted from the display apparatus 10 via the network 30 using an RFID label respective to each item currently stocked at the display apparatus. The processing device of the display apparatus server 20 may use the item identifier to detect a quantity of the item currently stocked at the display apparatus or to detect the presence of one or more misplaced items currently stocked at the display apparatus 10.

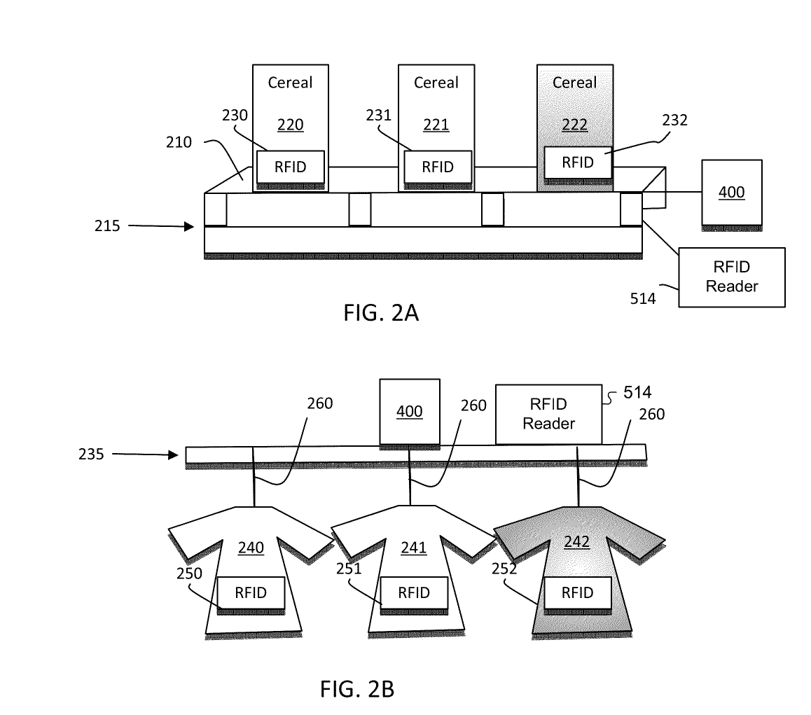

The display apparatus 10 may further be equipped with a display monitor (e.g., display monitor 400 of FIGS. 2A and 2B). In one embodiment, the display apparatus server 20 may retrieve item information corresponding to a selected item explicitly preferred by the retailer for being stocked at the display apparatus 10 from an item database. The item information can thereby be transmitted from the display apparatus server 20 to the display apparatus 10 via the network 30 and the item information can be displayed upon the display monitor. Item information can include information indicative of a description of the selected item, customer reviews of the selected item and current promotions being offered by the retailer related to the selected item.

FIGS. 2A-2B schematically illustrate the display apparatus of FIG. 1 including a display monitor 400. FIG. 2A schematically illustrates the display apparatus 10 corresponding a shelf apparatus 215. In the illustrated example, the shelf apparatus 215 is currently stocking boxes of cereal 220, 221, 222. The shaded box of cereal 222 corresponds to a misplaced item. For instance, the shaded box of cereal 222 can be a kid's cereal, wherein the retailer explicitly prefers to stock health conscious cereal on the shelf apparatus 215. The shelf apparatus 215 is equipped with an integrated scale 210 configured to weigh the items stocked on the shelf. Alternatively, or additionally, the shelf apparatus 215 is equipped with an RFID reader 514 configured to uniquely identify each of the items 220, 221, 222 by reading item identifiers broadcasted from each RFID label 230, 231, 232 corresponding to each of the items 222, 221, 222.

FIG. 2B schematically illustrates the display apparatus 10 corresponding to a garment rack apparatus 235. In the illustrated example, the garment rack apparatus 235 is currently stocking t-shirts 240, 241, 242. The shaded t-shirt 242 corresponds to a misplaced item. For instance, the shaded t-shirt 242 can be a women's t-shirt, wherein the retailer explicitly prefers to stock men's t-shirts on the garment rack apparatus 235. The garment rack apparatus 235 is equipped with an integrated scale 260 configured to weigh the items currently stocked on the garment rack apparatus 235. Alternatively, or additionally, the garment rack apparatus 235 is equipped with an RFID reader 514 configured to uniquely identify each of the items 240, 241, 242 by reading item identifiers broadcasted from each RFID label 250, 251, 252 corresponding to each of the items 222, 221, 222.

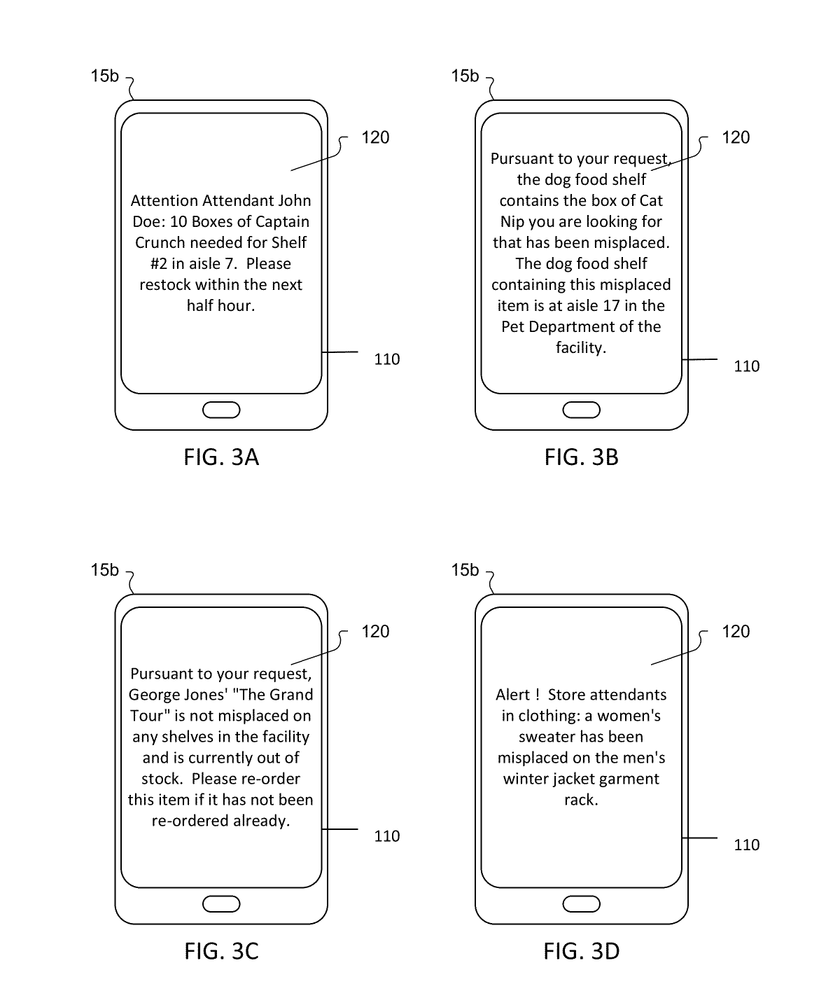

FIGS. 3A-3D schematically illustrate non-limiting examples of generated notifications displayed on a graphical user interface (GUI) of the retailer computing device of FIG. 1. The retailer computing device corresponds to the mobile computing device 15b corresponding to a facility attendant in the illustrated non-limiting examples. A stationary computing device could be used instead and is not restricted from being used. The mobile computing device 15b in each of FIGS. 3A-3D is displaying a GUI 120 on a touch screen 110 of the mobile computing device 15b. While a touch screen 110 is illustrated, it should be appreciated that other user interfaces can be used to allow a user to interact with the mobile computing device 15b. The graphical user interface may display at least one operational input that allows the user to provide a command, e.g., a search request, to the mobile computing device 10, the command causing the mobile computing device 10 to perform one or more operations.

It will be understood that the displayed notifications are not limited to any size or shape. Embodiments are envisioned where the notification can first be displayed as a smaller graphical feature such as a banner displayed on a portion of the GUI 120 that can be enlarged upon a user input, e.g., tapping, to expand the size of the banner. In one embodiment, the generated notification transmitted to the mobile computing device 15b can include a restocking request notification. The restocking request notification is provided to any mobile computing device corresponding to facility attendants having a responsibility to stock a given shelf. FIG. 3A illustrates a non-limiting example of a restocking request notification being indicative of a required quantity of a selected item, e.g., a box of cereal, needed to fulfill a desired quantity of the selected item stocked at a display apparatus. In this example, the restocking request notification further includes a time factor indicating a period of time, e.g., 10 minutes, that fulfilling the desired quantity of the selected item stocked at the display apparatus must be completed within and location specific information including the specific section of the facility at which the display apparatus is located.

In another embodiment, the generated notification transmitted to the mobile computing device 15b can include a misplaced item notification. The misplaced item notification can be provided to a facility attendant who transmitted a search request from the mobile computing device seeking the availability of a desired item. FIG. 3B illustrates a non-limiting example of a misplaced item notification based on a misplaced item identifiers retrieved from a misplaced item database that is equivalent to the search request, wherein the misplaced item corresponding to the retrieved misplaced item identifier includes the desired item, e.g., Cat Nip. The misplaced item identifier illustrated in FIG. 3B further includes a specific section of the facility at which the display apparatus currently stocking the misplaced item that includes the desired item is located.

In yet another embodiment, the generated notification transmitted to the mobile computing device 15b can include an unavailable item notification. The unavailable item notification can be provided to any facility attendant who transmitted a search request from the mobile computing device seeking the availability of a desired item. FIG. 3C illustrates a non-limiting example of an unavailable item notification indicating that the desired item, e.g., George Jones' “The Grand Tour”, is not able to be located in the facility if none of the misplaced item identifiers stored in the misplaced item database are equivalent to the search request.

In yet another embodiment, the generated notification transmitted to the mobile computing device 15b can include an alert notification. The alert notification can be provided to any facility attendant responsible for removing misplaced items currently stocked on the wrong display apparatus. Specific facility attendants may be designated to receive the alert notification or may be selected based on a proximity to the display apparatus currently stocking the misplaced item. FIG. 3D illustrates a non-limiting example of an alert notification indicating the detected presence of one or more misplaced items, e.g., a women's shirt, currently stocked at a garment rack apparatus intended to stock men's winter jackets.

The examples of FIGS. 3A-3D are provided for example only and not intended to be limiting. It will be appreciated that the generated notification is not limited to one type or classification, but each generated notification may include any combination of the restocking request, misplaced item, unavailable item, and alert notifications transmitted to the mobile computing device 15b and based on a detected quantity of a selected item being less than a threshold and/or a detected presence of one or more misplaced items currently stocked at a display apparatus. Furthermore, variations of the GUI 120 are contemplated and are within the scope of the disclosure.

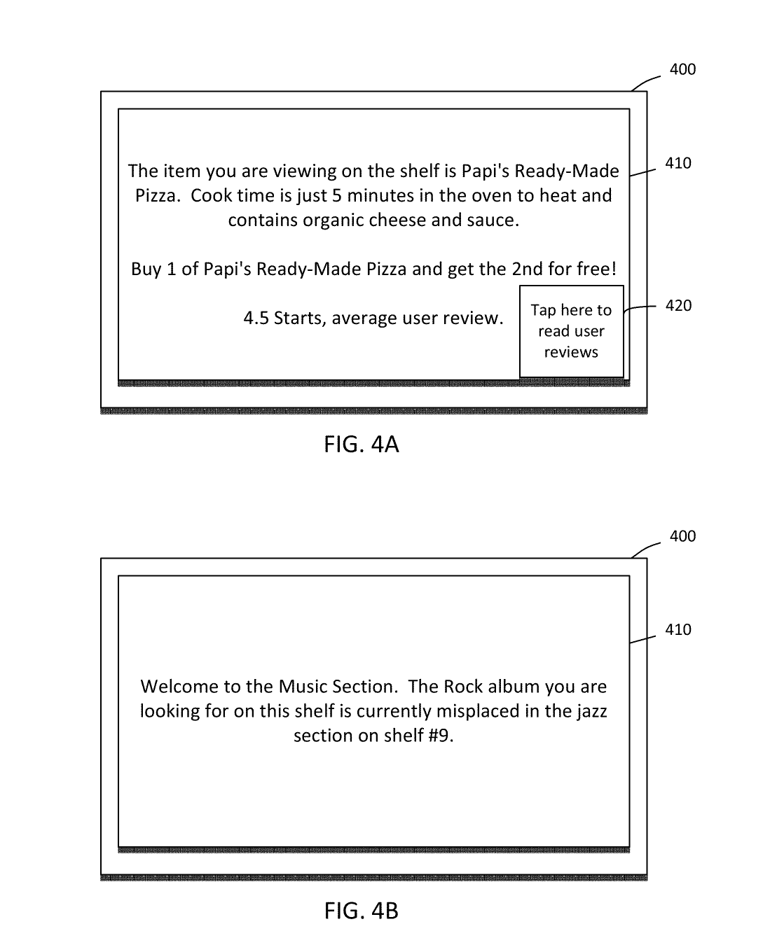

FIGS. 4A-4B schematically illustrate non-limiting examples of information displayed on the display monitor of FIGS. 2A-2B. The display monitor 400 in each of FIGS. 4A-4B is displaying a GUI 410 on a touch screen of the display monitor 400. While a touch screen is illustrated, it should be appreciated that other user interfaces can be used to allow a user to interact with the display monitor 400. The GUI may display at least one operational input, e.g. a push button 420 as illustrated in FIG. 4A, that allows the user to provide a command to the mobile computing device 10, the command causing the mobile computing device 10 to perform one or more operations. In one embodiment, the display monitor 400 is provided to display item information corresponding to a selected item explicitly preferred for being stocked at the associated display apparatus. The item information is transmitted to the associated display apparatus and displayed upon the display monitor 400. The item information may be indicative of a description of a selected item, customer reviews of the selected and current promotions being offered by the retailer related to the selected item. In a non-limiting example, FIG. 4A illustrates item information transmitted to the display monitor 400 for display. The operational input including the push button 420 can be utilized to receive an input from a shopper to read the user reviews. In another embodiment, a location specific notification can be transmitted to a first display apparatus indicative of location specific information indicating a specific section of the facility at which the display apparatus currently stocking a detected presence of one or more misplaced items is located. In a non-limiting example, FIG. 4B illustrates a location specific notification including the location specific information to the display monitor 400 corresponding to a second display apparatus at which the detected presence of the one or more misplaced items, e.g., Rock Album, are explicitly preferred by the retailer for being stocked. For instance, a customer is looking for the rock album on a rock shelf (e.g., second display apparatus) that should stock the rock album, but the rock album is currently misplaced at a jazz shelf (e.g., first display apparatus).

The examples of FIGS. 4A-4B are provided for example only and not intended to be limiting. It will be appreciated that the information displayed on the display monitor is not limited to any classification of information, but the displayed information may include item information corresponding to a selected item explicitly preferred to be stocked by the retailer at a corresponding display apparatus and/or a location specific notification indicating the location of where a misplaced item is currently stocked that should be stocked at the corresponding display apparatus.

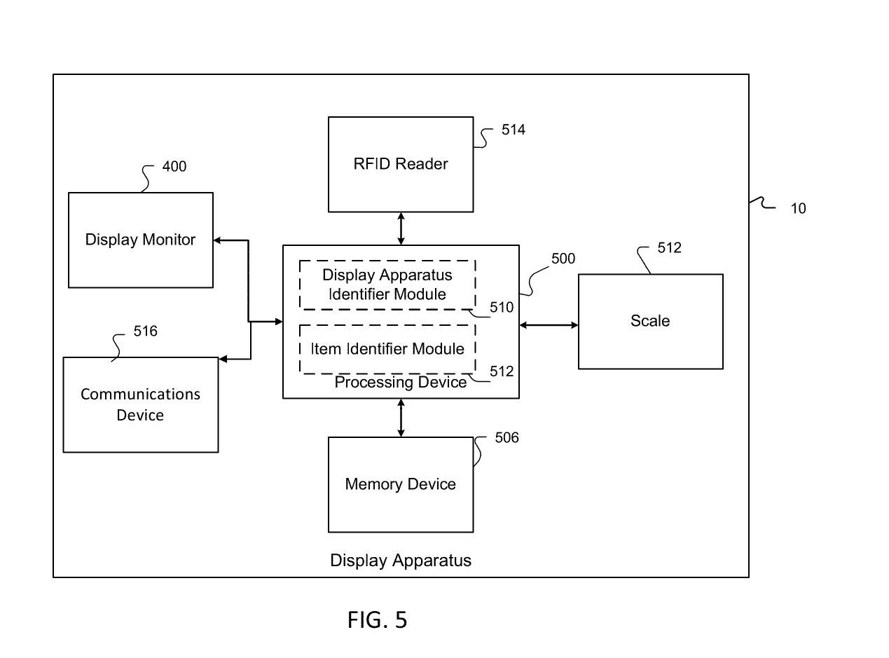

Referring now to FIG. 5, a block diagram illustrating example components of the display apparatus 10 of FIG. 1 is depicted. In the example embodiment, the display apparatus 10 includes a processing device 500, a memory device 506, a scale 512, an RFID reader 514, a communications device 516 and a display monitor 400.

The processing device can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 500 can execute the operating system of the display apparatus. In the illustrative embodiment, the processing device 500 also includes a display apparatus identifier module 510 for transmitting a display apparatus identifier to the display apparatus server 20 of FIG. 1 and an item identifier module 512 for transmitting an item identifier to the display apparatus server 20 of FIG. 1.

The communication device 516 is a device that allows the display apparatus 10 to communicate with another device, e.g., the display apparatus server 20, via the network 30. The communication device 516 can include one or more wireless transceivers for performing wireless communication and/or one or more communication ports for performing wired communication. The memory device 508 is a device that stores data generated or received by the display apparatus 10. The memory device 106 can include, but is not limited to a hard disc drive, an optical disc drive, and/or a flash memory drive. The memory device 508 can include storage for monitoring items currently stocked on the display apparatus 10.

The RFID reader 514 is a device integrated within the display apparatus that can uniquely identify items currently stocked on the display apparatus that include RFID tags. The identified items can be communicated to the item identifier module 512. The scale 512 is a device integrated within the display apparatus that can weigh one or more items currently stocked at the display apparatus. The weight can be communicated to the memory device 508 for storage. The display monitor 400 is a device configured to display item information or notifications transmitted through the communications device 516.

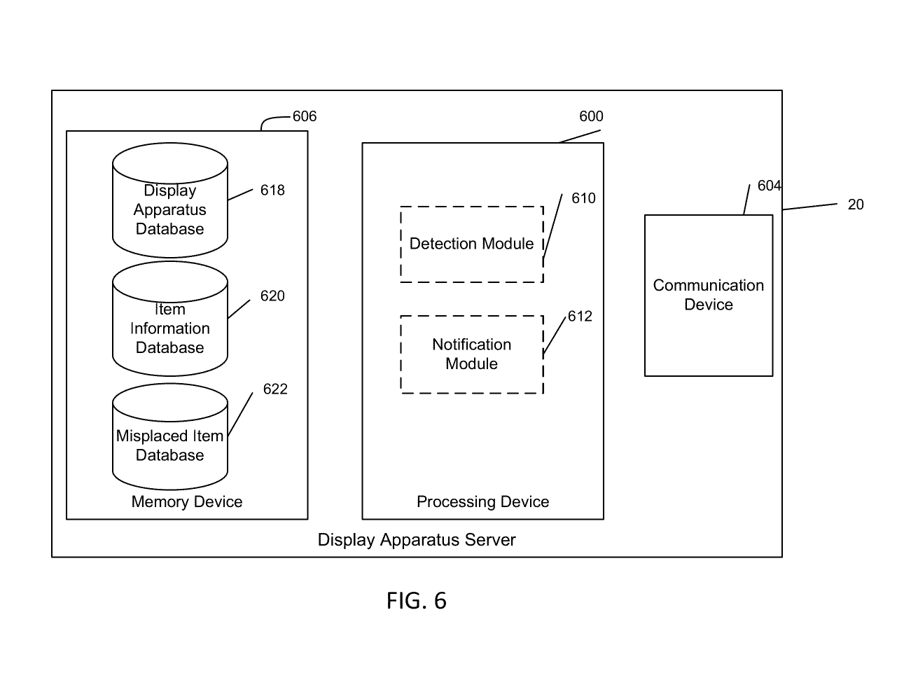

Referring now to FIG. 6, a block diagram illustrating example components of the display apparatus server 20 of FIG. 1 is depicted. In an exemplary embodiment, the display apparatus server 20 includes a processing device 600, a communication device 604, and a memory device 606.

The processing device 600 can include memory, e.g., read only memory (ROM) and random access memory (RAM), storing processor-executable instructions and one or more processors that execute the processor-executable instructions. In embodiments where the processing device 600 includes two or more processors, the processors can operate in a parallel or distributed manner. In the illustrative embodiment, the processing device 600 executes a detection module 610 and a notification module 612, which are described in greater detail below.

The detection module 610 can receive a display apparatus identifier broadcasted from the display apparatus and thereafter detect a quantity of a selected item currently stocked at a display apparatus. For instance, the detection module 610 can receive a monitored weight of one or more items currently stocked at the display apparatus 10 using a scale integrated within the display apparatus 10 and estimate the quantity of the selected item currently stocked at the display apparatus based on the monitored weight of the one or more items currently stocked and a known weight of the selected item. It will be appreciated, that estimating the quantity of the selected item currently stocked at the display apparatus 10 using an integrated scale does not account for items that are misplaced at the display apparatus. In another instance, the detection module 610 can more accurately detect the quantity of the selected item when each item currently stocked at the display apparatus includes a respective RFID label. However, one will appreciate that certain items cannot always include RFID labels, such as produce, and in such instances an integrated scale to estimate the quantity of the selected item may be preferred.

Other embodiments include the detection module 610 receiving an apparatus identifier and one or more item identifiers broadcasted from the display apparatus and thereafter detecting a presence of one or more misplaced items currently stocked at the display apparatus. For instance, each item identifier received at the detection module 610 may correspond to a respective item currently stocked at the display apparatus 10, and the presence of one or more misplaced items can be detected based on each misplaced item having a misplaced item identifier that does not correspond to a selected item explicitly preferred by the retailer for being stocked at the display apparatus. In this scenario, the selected item can be determined based on the received display apparatus identifier.

The notification module 612 generates a request notification to replenish the display apparatus with the selected item in response to the detected quantity of the selected item not being greater than a threshold. The threshold can be equal to one indicating display apparatus is out of stock. Similarly, the threshold can include a number greater than one but indicative of a quantity suggesting that the display apparatus will be out of stock soon. The request notification can include a restocking request indicating a desired quantity needed to fulfill the replenishing of the display apparatus 10. The request notification can further include a time factor indicating a time period that fulfilling a desired quantity of the selected item stocked at the display apparatus must be completed within. Accordingly, the notification module 612 can monitor a rate at which the quantity of the selected item is decreasing to determine the time factor indicating the time period. In other embodiments, the notification module 612 can generate a notification based on a detected presence of one or more items currently stocked at the display apparatus. The generated notification can include any combination of a misplaced item notification, an unavailable item notification, a location specific notification and an alert notification to the retailer computing device 15 discussed above in the non-limiting examples provided in FIGS. 3A-3D. Likewise, the generated notification can include information transmitted to a display monitor associated with a display apparatus. The information may include item information corresponding to a selected item explicitly preferred to be stocked by the retailer at a corresponding display apparatus and/or a location specific notification indicating the location of where a misplaced item is currently stocked, as discussed above in the non-limiting examples provided in FIGS. 4A-4B.

The communication device 604 is a device that allows the display apparatus server 20 to communicate with another device, e.g., the display apparatus 10, via the network 20. The communication device 604 can include one or more wireless transceivers for performing wireless communication and/or one or more communication ports for performing wired communication.

The memory device 606 is a device that stores data generated or received by the display apparatus server 20. The memory device 606 can include, but is not limited to, a hard disc drive, an optical disc drive, and/or flash memory drive. Further, the memory device 606 may be distributed and located at multiple locations. The memory device 606 is accessible to the processing device 600.

A display apparatus database 618, or similar structure, can be stored in the memory device 606. In an exemplary embodiment, a retailer maintains the display apparatus database 618 to input and store display apparatus information for one or more display apparatuses furnished by the retailer. For instance, a facility manager may input display apparatus information for one or more display apparatuses within the facility using the retailer computing device 15 of FIG. 1. The display apparatus information can include display apparatus preferences being indicative of a selected item explicitly preferred by the retailer for being stocked at a display apparatus, a desired quantity of the selected item stocked at the display apparatus and a weight of the selected item. The display apparatus information can further include location specific information indicating a specific section of the facility at which a display apparatus is located. The display apparatus information can be retrieved by the detection and/or notification modules 610, 612, respectively, using a display apparatus identifier broadcasted from the display apparatus 10 of FIG. 1 and received by the detection module 610. For instance, the detection module 610 can detect a quantity of a selected item currently stocked at the display apparatus and determine if the display apparatus needs to be replenished with the selected item. Similarly, the notification module 612 can generate a request notification to replenish the display apparatus with the selected item.

Additionally, an item information database 620, or similar structure, can be stored in the memory device 606. In an exemplary embodiment, the retailer maintains the item information database 620 to store item information corresponding to items being offered for sale by the retailer. The item information corresponding to a selected item may be retrieved from the item information database 620 by the notification module 612, wherein the notification module 612 can generate a notification indicative of the item information to a display monitor corresponding to the display apparatus. Thereafter, the item information can be displayed and viewed by customers located at the display apparatus 10. The item information can include information indicative of a description of the selected item, customer reviews of the selected item and current promotions being offered by the retailer related to the selected item. The customer reviews can be obtained from a facility website.

Further, a misplaced item database 622, or similar structure, can be stored in the memory device 606. In an exemplary embodiment, the misplaced item database 622 is updated upon the detected presence of one or more misplaced items being stocked at a display apparatus, wherein each misplaced item corresponds to a respective misplaced item identifier. For instance, the detection module 610 can detect a presence of one or more misplaced items currently stocked at a display apparatus having misplaced item identifiers that do not correspond to a selected item explicitly preferred by the retailer for being stocked at the display apparatus, wherein the selected item is included within the display apparatus information that is stored in the display apparatus database 618 and retrieved by the detection module 610. The misplaced item identifiers can be retrieved from the misplaced item database 622 in response to a search request broadcasted from the retailer computing device 15 of FIG. 1 and received by the detection module 610. For example, a misplaced item identifier is retrieved if it is equivalent to the search request, wherein the notification module 612 can subsequently generate a misplaced item notification indicating the misplaced item identifier for transmission back to the retailer computing device 15. FIGS. 3B-3D and 4B illustrate non-limiting examples of notifications generated by notification module 412 that are indicative of misplaced items.

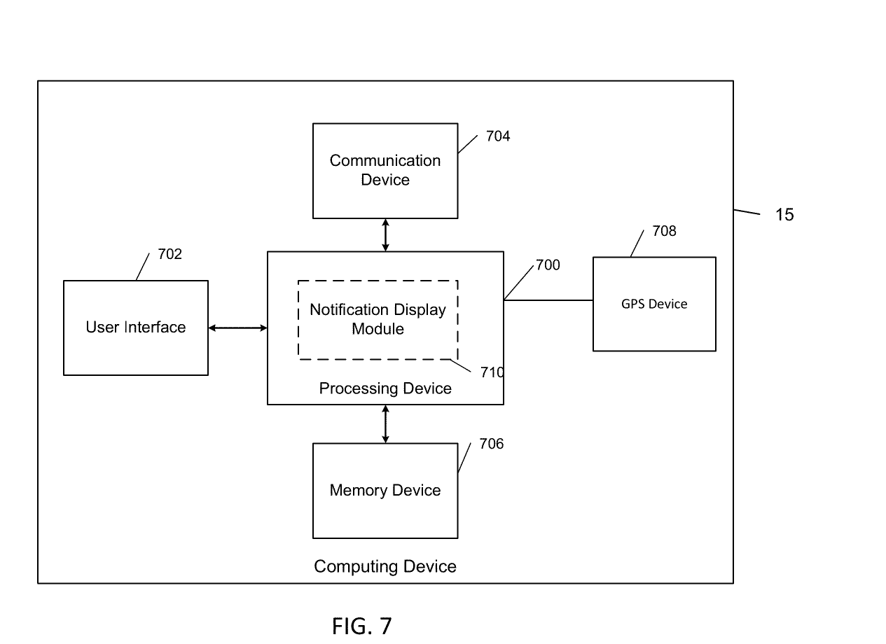

Referring now to FIG. 7, a block diagram illustrating example components of the retailer computing device 15 of FIG. 1 is depicted. In the example embodiment, the computing device 15 includes a processing device 700, a user interface 702, a communication device 704, a memory device 706 and a GPS device 708.

The processing device 700 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 700 can execute the operating system of the computing device. In the illustrative embodiment, the processing device 700 also includes a notification display module 710 for displaying a notification transmitted from the display apparatus server 20 of FIG. 1. The notification display module 710 may provide the interface graphic in the GUI and allow the user to provide the command to the computing device 15 to execute one or more operations relating to the interface graphic.

The user interface 702 is a device that allows a user to interact with the computing device 15. While one user interface 702 is shown, the term “user interface” can include, but is not limited to, a touch screen, a physical keyboard, a mouse, a microphone, and/or a speaker. The communication device 704 is a device that allows the mobile computing device 15 to communicate with another device, e.g., the display apparatus server 20. The communication device 704 can include one or more wireless transceivers for performing wireless communication and/or one or more communication ports for performing wired communication. The memory device 706 is a device that stores data generated or received by the computing device 15. The memory device 706 can include, but is not limited to a hard disc drive, an optical disc drive, and/or a flash memory drive. The memory device 706 can include storage for a list of restocking request notifications or a list of misplaced items including maps for directions to display apparatuses requiring replenishing or retrieval of misplaced items. The GPS device 112 can provide a location of the computing device 15 within the facility. For instance, the location of the computing device 15 can be obtained by the display apparatus server 20 to locate a facility attendant nearest to a display apparatus currently stocking a misplaced item or requiring replenishing.

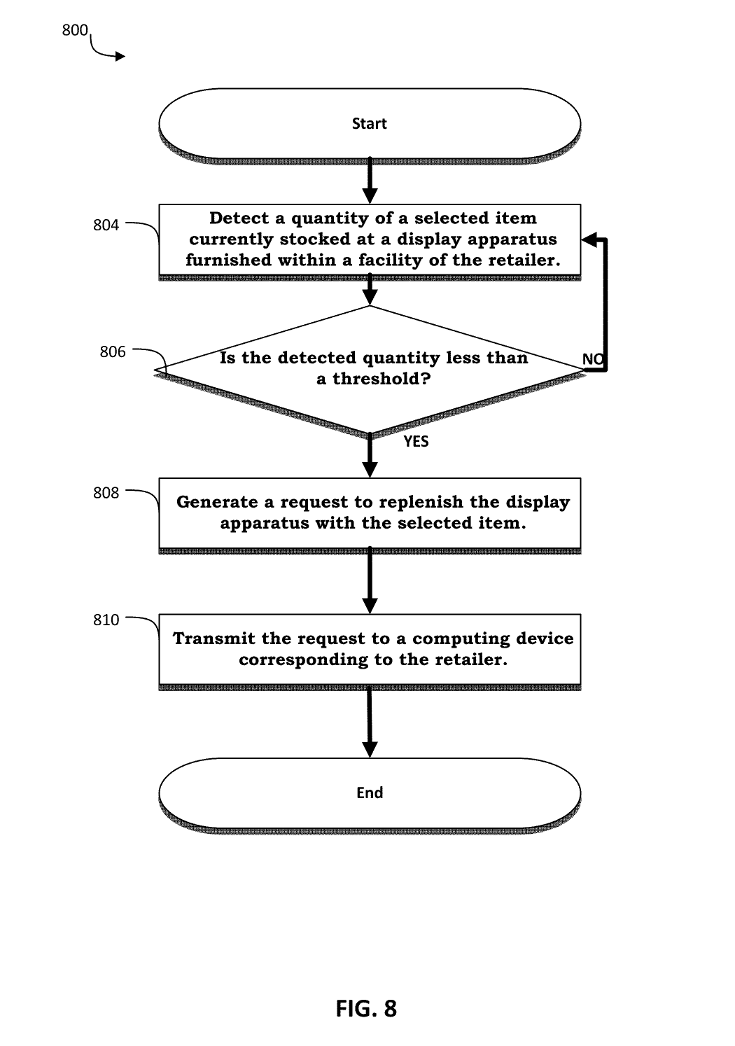

FIG. 8 illustrates an example method of a flowchart 800 that can be executed by the display apparatus server 20 sending requests from the display apparatus server 20 to the retailer computing device 15 corresponding to a user. At operation 804, the detection module 610 detects a quantity of a selected item currently stocked at the display apparatus 10 furnished within the facility of the retailer. In one embodiment, the detected quantity can be estimated using the integrated scale within the display apparatus based on the total weight of the items currently stocked at the display apparatus and a known weight of the selected item. In another embodiment, the detected quantity can be determined based on a quantity of received item identifiers corresponding to the selected quantity. At operation 804, a decision is made on whether the detected quantity is less than a threshold. The threshold can correspond to one item or the item can corresponding a desired value indicative of the current stock of the item running low and the display apparatus 10 requiring replenishment. If the detected quantity is not less than the threshold, the flowchart 800 iteratively reverts back to operation 804. If the detected quantity is less than the threshold, the flowchart 800 iteratively proceeds to operation 808.

At operation 808, the notification module 612 generates a request to replenish the display apparatus 10 with the selected item. The selected item can be obtained by retrieving display apparatus information from the display apparatus database 618 using a display apparatus identifier broadcasted from the display apparatus 10 and received by the detection module 610. As aforementioned, the notification module 612 can include a restocking request notification being indicative of a required quantity of the selected item needed to fulfill the desired quantity of the selected item stocked at the display apparatus 10. In one exemplary embodiment, the restocking request notification can include a time factor indicating a time period that fulfilling the desired quantity of the selected item stocked at the display apparatus must be completed within. In another embodiment, the generated request notification further includes the specific section of the facility at which the display apparatus 10 is located using the display apparatus information retrieved from the display apparatus database 618.

At operation 810, the notification module 612 transmits the generated notification to the retailer computing device 15. In one embodiment, the retailer computing device 15 can include one or more mobile computing devices corresponding to one or more facility attendants. In another embodiment, the retailer computing device 15 can include a stationary computing device located in a specific section of the facility, e.g., a manager's stationary computer in the produce compartment. The notification module 612 can additionally or alternatively transmit notifications indicative of item information corresponding to the selected item to a display monitor corresponding to the display apparatus 10 that currently stocks the selected item. For instance, the display monitor can display the item information including, but not limited to, a description of the selected item, customer reviews of the selected item and current promotions being offered by the retailer related to the selected item.

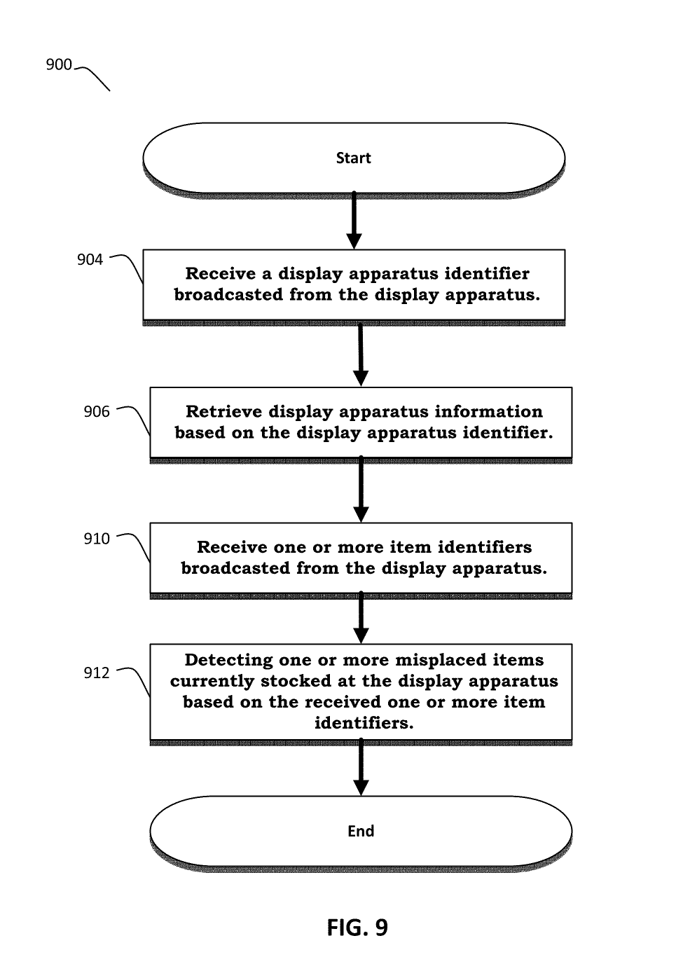

FIG. 9 illustrates an example method of a flowchart 900 that can be executed by the display apparatus server 20 for detecting a presence of one or more misplaced items currently stocked at the display apparatus 10. At operation 904, the detection module 610 receives a display apparatus identifier broadcasted from the display apparatus 10. At operation 906, the detection module 610 retrieves display apparatus information from the display apparatus database 608 using the display apparatus identifier. The display apparatus information includes display apparatus preferences being indicative of a selected item explicitly preferred by the retailer for being stocked at the display apparatus and location specific information indicating a specific section of the facility at which the display apparatus is located.

At operation 908, the detection module 610 receives one or more item identifiers broadcasted from the display apparatus, each item identifier corresponding to a respective item currently stocked at the display apparatus. As aforementioned, the received one or more item identifiers are broadcasted from the display apparatus using a radio frequency identification (RFID) label corresponding to each item currently stocked at the display apparatus 10, each item indicating a product being offered for sale by the retailer.

At operation 910, the detection module 610 detects a presence one or more misplaced items currently stocked at the display apparatus 10 based on the received one or more item identifiers. Each misplaced item has a misplaced item identifier that does not correspond to the selected item explicitly preferred by the retailer for being stocked at the display apparatus.

Thereafter, the notification module 612 can send an alert notification indicating the detected presence of the one or more misplaced items currently stocked at the display apparatus 10 and subsequently transmit the alert notification to the retailer computing device 15. Additionally, or alternatively, each misplaced item identifier is stored in the misplaced item database 622 and be associated the location specific information for the display apparatus at which each misplaced item is currently stocked. In one embodiment, in response to a search request seeking the availability of a desired item that is broadcasted from the retailer computing device 15 and received by the detection module 610, the notification module 612 can generate a misplaced item notification indicating the misplaced item identifier retrieved from the misplaced item database 622 that corresponds to the desired item. Likewise, the notification module 612 can generate an unavailable item notification indicating that none of the misplaced item identifiers stored in the misplaced item database 622 correspond to the desired item. The specific section of the facility at which the display apparatus currently stocking the misplaced item can also be included within the generated notifications by the notification module 612.

The above description of illustrated examples of the present invention, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

1. At a computer system monitoring a retail display, a method for requesting restocking of the retail display, comprising:
receiving communication from an item information database, the communication indicating a type of item that has been selected to be offered for sale at the retail display, the communication including item information for the selected item type, the item information including a per item weight for items of the selected item type;
receiving RFID labels for each of a plurality of items stocked at the retail display;
detecting that there are no misplaced items at the retail display based on the received RFID labels by detecting that each of the received RFID labels correspond to an item of the selected item type;
receiving a total weight of items at the retailer display from a scale;
estimating a quantity of items of the selected item type currently stocked at the retail display based on the per item weight and the total weight;
determining that the estimated quantity of items is less than a threshold; and
transmitting a restocking notification to restock the retail display to another computer system in response to the determination.

2. (canceled)

3. The method of claim 1, wherein the threshold is stored in the display preferences being indicative of the selected item explicitly preferred by the retailer for being stocked at the retail display.

4. (canceled)

5. The method of claim 3, wherein the restocking notification comprises a restocking request notification being indicative of a required quantity of the selected item needed to fulfill the desired quantity of the selected item stocked at the display apparatus.

6. The method of claim 5, wherein the restocking notification includes a time factor indicating a period of time that fulfilling the desired quantity of the selected item stocked at the display apparatus must be completed within.

7. The method of claim 1, further comprising retail display information that includes location specific information indicating a specific section of a facility wherein the retail display is located, wherein the generated request notification further includes the specific section of the facility.

8. (canceled)

9. The method of claim 1, further comprising:
transmitting the item information to a display monitor at the retail display; and
displaying the item information upon the display monitor.

10. The method of claim 1, wherein the item information includes information indicative of a description of the selected item, customer reviews of the selected item and current promotions being offered by the retailer related to the selected item.

11. The method of claim 7, wherein transmitting a restocking notification comprises transmitting a restocking notification to one of: a mobile computing device corresponding to a facility attendant of the retailer and a stationary computing device corresponding to a specific section of the facility.

12. The method of claim 1, wherein the retail display is selected from the group consisting of: a shelf apparatus and a garment rack apparatus.

13. At a computer system for a retailer, the computer system including a detection module and notification module comprising:
a processor;
system memory;
the computer system configured to receive communication from an item information database, the communication indicating a type of item that has been selected to be offered for sale at a retail display, the communication including item information for the selected item type, the item information including a per item weight for items of the selected item type;
the detection module configured to:
receive RFID labels for each of a plurality of items stocked at the retail display;
detect that there are no misplaced items at the retail display based on the received RFID labels by detecting that each of the received RFID labels correspond to an item of the selected item type;
receive a total weight of items at the retailer display from a scale;
estimate a quantity of items of the selected item type currently stocked at the retail display based on the per item weight and the total weight; and
determine that the estimated quantity of items is less than a threshold; and
the notification module configured to transmit a restocking notification to restock the retail display to another computer system in response to the determination.

14. (canceled)

15. The computer system of claim 13, wherein the threshold is stored in display preferences being indicative of the selected item explicitly preferred by the retailer for being stocked at the retail display.

16. (canceled)

17. The computer system of claim 13, wherein the restocking notification comprises a restocking request notification being indicative of a required quantity of the selected item needed to fulfill the desired quantity of the selected item stocked at the display apparatus.

18. The computer system of claim 17, wherein the restocking notification includes a time factor indicating a period of time that fulfilling the desired quantity of the selected item stocked at the display apparatus must be completed within.

19. The computer system of claim 13, further comprising retail display information for a plurality of retail displays that includes location specific information indicating a specific section of a facility where each retail display apparatus is located.

20. (canceled)

21. (canceled)

22. The computer system of claim 13, wherein the item information includes customer reviews of the selected item and current promotions being offered by the retailer related to the selected item.

23. The computer system of claim 13, wherein transmitting a restocking notification comprises transmitting a restock notification to one of: a facility attendant of the retailer and a stationary computing device corresponding to a specific section of the facility.

24. The computer system of claim 13, wherein the retail display is selected from the group consisting of: a shelf apparatus and a garment rack apparatus.
